(19) United States
(12) Patent Application Publication
(10) Pub. No.: US 2025/0075739 A1
(43) Pub. Date: Mar. 6, 2025

(54) CAGE FOR ROLLING ELEMENT BEARINGS

(71) Applicant: AKTIEBOLAGET SKF, GOTEBORG (SE)

(72) Inventor: Bryan D. ALLISON, Clymer, NY (US)

(21) Appl. No.: 18/457,477

(22) Filed: Aug. 29, 2023

(51) Int. Cl. F16C 33/44; F16C 33/66

(52) U.S. Cl. CPC F16C 33/445; F16C 33/6696

(57) ABSTRACT

A cage for a bearing includes an annular body formed of a composite material and having a centerline, the body being sized to be disposed between the inner and outer rings of the bearing and having a first axial end, a second axial end, an inner circumferential surface and an outer circumferential surface. A plurality of pockets are spaced circumferentially about the centerline, disposed between the first and second axial ends and extend radially between the inner and outer circumferential surfaces. Each pocket is sized to receive one of the rolling elements. The composite material includes a mixture of a polymer base, reinforcing fibers and a lubricant. Preferably, the polymer base is ultrahigh weight polyethylene or polyetherimide, the reinforcing fibers are short strand carbon fibers and are between ten and thirty percent by weight, and the lubricant is molybdenum disulfide and is one half percent to ten percent by weight.

### BACKGROUND OF THE INVENTION

The present invention relates to bearings, and more particularly to cages for rolling element bearings.

Cages for rolling element bearings are well known and typically include an annular body with a plurality of circumferentially-spaced pockets, each pocket receiving a separate one of the rolling elements of the bearing. The cage establishes a desired spacing between adjacent rolling elements and guides the elements as the elements traverse a pitch circle defined between the bearing inner and outer rings.

In certain applications which require a substantially sterile environment, such as in semiconductor manufacturing or in the food processing industry, the bearing cages are often formed of a polymeric material, such as polyether ether ketone (“PEEK”). However, the cost of fabricating a cage out of PEEK and similar materials is relatively expensive and require substantial production volumes in order to be relatively affordable. If formed by injection molding, the tooling cost alone may exceed one hundred thousand dollars and even if fabricated by machining from a disk of material, the material price and manufacturing costs result in the PEEK cages being relatively expensive to produce.

### SUMMARY OF THE INVENTION

In one aspect, the present invention is a cage for a bearing, the bearing including inner and outer rings and a plurality of rolling elements disposed between the inner and outer rings. The cage comprises an annular body formed of a composite material and having a centerline, the body being sized to be disposed between the inner and outer rings and having a first axial end, a second axial end, an inner circumferential surface and an outer circumferential surface. A plurality of pockets are spaced circumferentially about the centerline, are disposed between the first and second axial ends and extend radially between the inner and outer circumferential surfaces. Each pocket is sized to receive a separate one of the rolling elements. The composite material including a mixture of a polymer base, reinforcing fibers and a lubricant. Preferably, the polymer base is ultrahigh weight polyethylene or polyetherimide, the reinforcing fibers are short strand carbon fibers in an amount of between ten percent (10%) by weight and thirty percent (30%) by weight, and the lubricant is molybdenum disulfide in an amount of between one half percent (0.5%) by weight and ten percent (10%) by weight.

In another aspect, the present invention is a method of forming a cage for a bearing having an inner ring, an outer ring and a plurality of rolling elements disposed between the inner and outer rings. The method comprises the steps of: providing a tube of a composite material, the composite material including a mix of a base polymer, reinforcing fibers and lubricant; machining the outer surface of the tube to a desired outside diameter of the cage and the inner surface of the tube to a desired inside diameter of the cage; cutting the tube to provide at least one annular body having a desired axial length of the cage; and machining a plurality of pockets in the annular body spaced circumferentially about a centerline of the body, each pocket extending radially between the inner surface of the body and the outer surface of the body. The method may further comprise the step of machining at least one cavity and/or at least one groove in an enclosed inner surface of at least one of the pockets, the cavity and/or groove being configured to contain lubricant.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a side plan view through a bearing including a cage of the present invention, the bearing shown coupling a shaft with an outer member of a machine;

FIG. 2 is a perspective view of the cage;

FIG. 3 is a broken-away, enlarged axial cross-sectional view of the cage;

FIG. 4 is a detail view of a section of FIG. 3 indicated by arrow 4;

FIG. 5 is a broken-away, more enlarged axial cross-sectional view of the cage, shown with a plurality of lubricant cavities on an inner surface of a pocket;

FIG. 6 is another broken-away, more enlarged axial cross-sectional view of the cage, shown with a lubricant groove on an inner surface of a pocket;

FIG. 7 is a perspective view of a tube of composite material used to fabricate a plurality of the cages;

FIG. 8 is a plurality of cages bodies formed from the tube depicted in FIG. 7; and

FIG. 9 is depiction of a step of machining pockets in of the one cage bodies shown in FIG. 8.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. The terminology includes the words specifically mentioned above, derivatives thereof, and words of similar import.

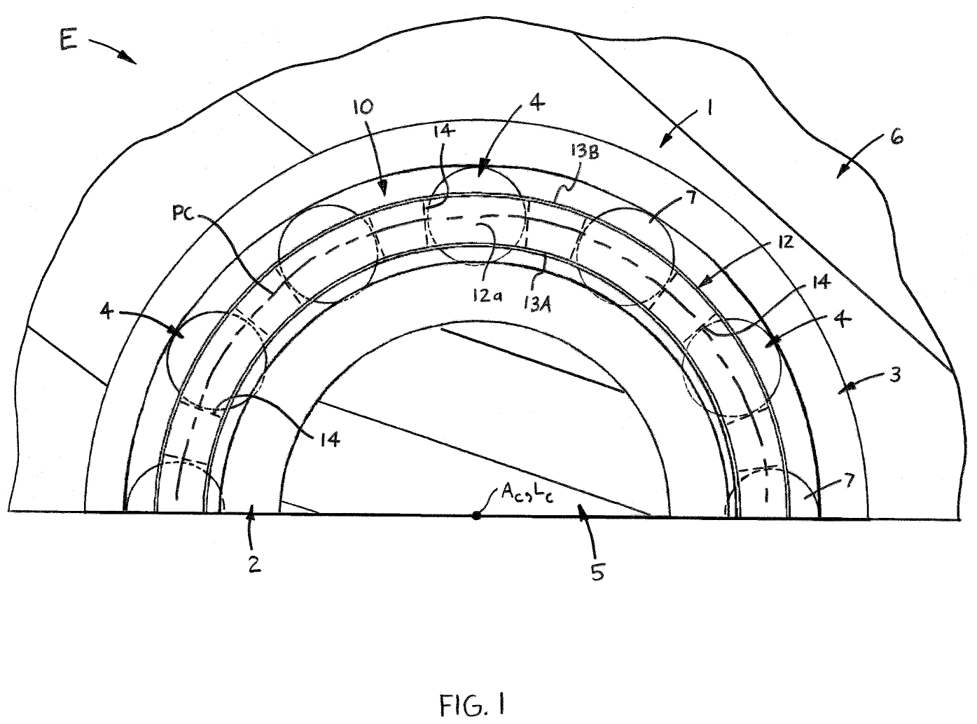

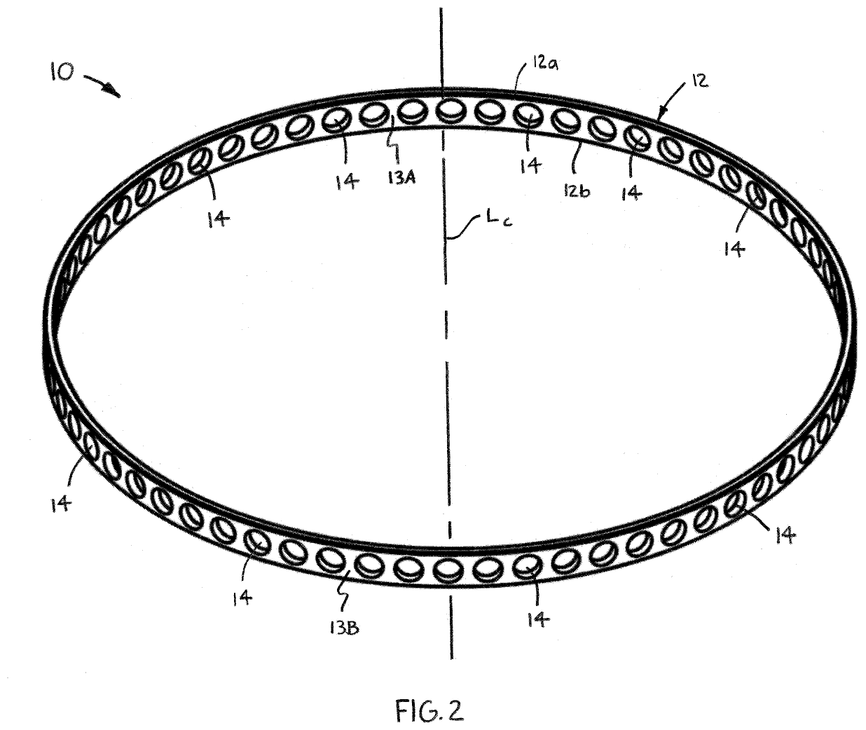

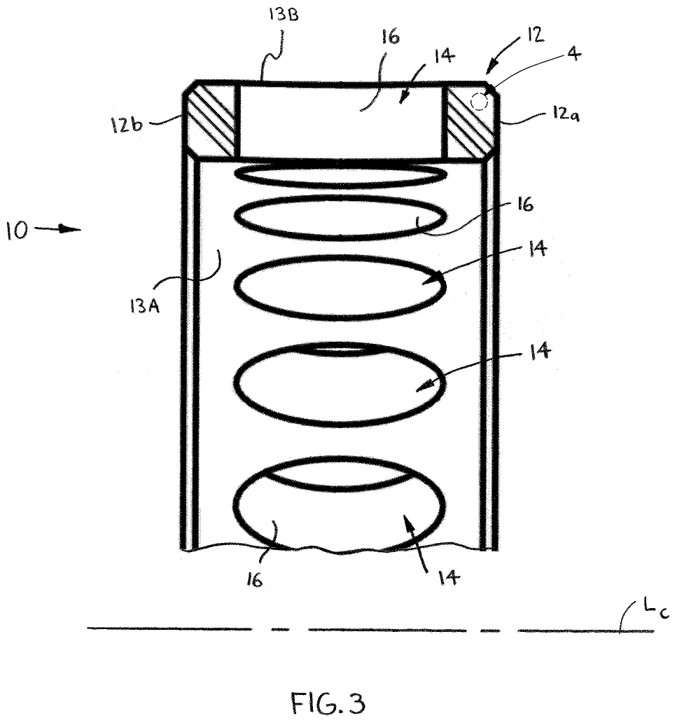

Referring now to the drawings in detail, wherein like numbers are used to indicate like elements throughout, there is shown in FIGS. 1-9 a cage 10 for a bearing 1, the bearing 1 including an inner ring 2, an outer ring 3 disposed about the inner ring 2 and a plurality of rolling elements 4 disposed between the inner and outer rings 2, 3. The bearing 1 functions to rotatably couple an inner member 5, such as a shaft, with an outer member 6, for example a housing or hub, so that one member 5 or 6 rotates about a central axis Ac as the rolling elements 1 traverse a pitch circle PC (FIG. 1) defined between the rings 2, 3. Preferably, the inner and outer members 5, 6 are components or structural members of a machine or item of equipment E used in a sterile environment, such as semiconductor manufacturing, food processing, etc., but may be used in any other appropriate application.

The cage 10 comprises an annular body 12 formed of a composite material M and having a centerline L_{C}, the body 12 being sized to be disposed between the inner and outer rings 2, 3. The cage annular body 12 has a first axial end 12a, a second axial end 12b, an inner circumferential surface 13A and an outer circumferential surface 13B. Further, a plurality of pockets 14 are spaced circumferentially about the centerline L_{C}, are disposed between the first and second axial ends 12a, 12b and extend radially between the inner and outer circumferential surfaces 13A, 13B. Each pocket 14 is sized to receive a separate one of the rolling elements 4 such that the rolling element 4 is free to rotate within the pocket 14 as the element 4 traverses the bearing pitch circle PC.

More specifically, each pocket 14 is defined by a separate one of a plurality of enclosed surfaces 16 formed in the annular body 12 and having an inside diameter or inside dimension (neither indicated) that is slightly greater than a diameter and/or length of each rolling element 4. In a presently preferred and depicted application, the rolling elements 4 are balls 7 and each pocket 14 is circular. However, the rolling elements 4 may alternatively be cylinders, needles, tapered rollers, etc. (none depicted), such that each pocket 4 may be formed rectangular, frustoconical, etc. (none depicted).

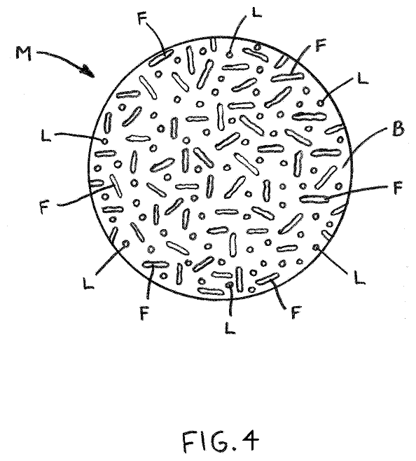

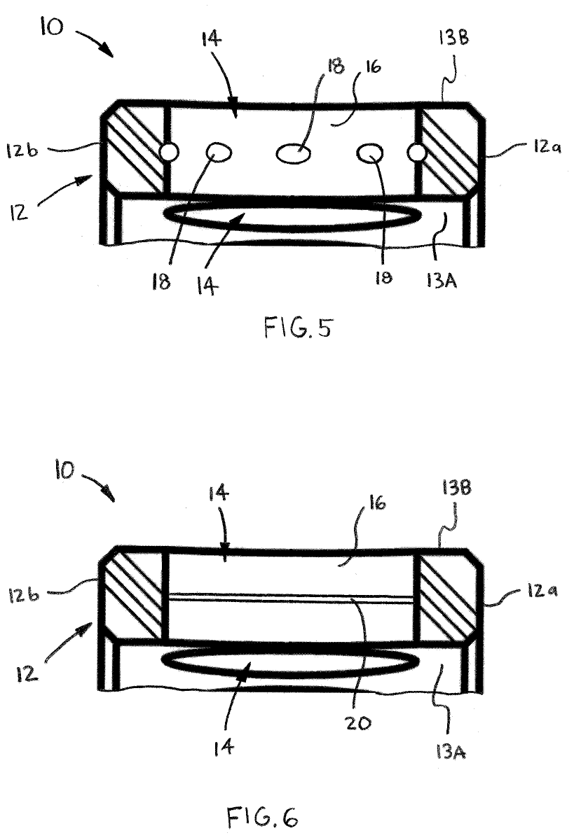

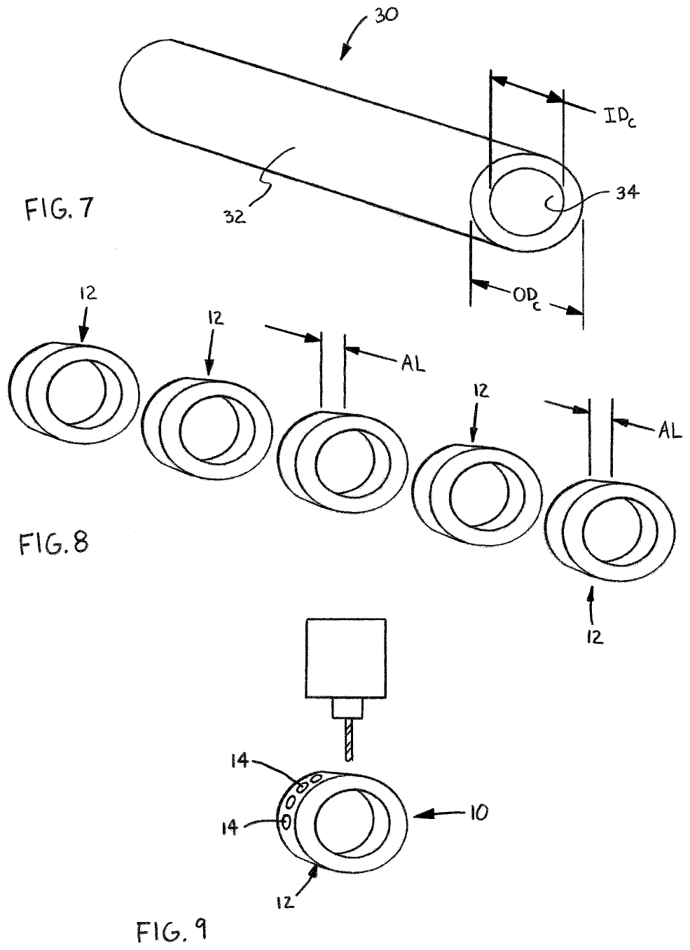

Furthermore, the composite material M includes a mixture of a polymer base B, reinforcing fibers F and a lubricant L, as depicted in FIG. 4. Preferably, the amount of the reinforcing fibers F in the composite material M is between ten percent by weight (10%) and thirty percent (30%) by weight and an amount of the lubricant L in the composite material M is between one-half percent (0.5%) by weight and ten percent (10%) by weight. Most preferably, the amount of the reinforcing fibers F is about thirty percent (30%) by weight and the amount of the lubricant L is about five percent (5%) by weight. However, the composite material M may alternatively include any other desired amount of reinforcing fibers F and/or lubricant L as suitable for a particular application.

Preferably, the reinforcing fibers F includes short strand carbon fibers, the lubricant L includes molybdenum disulfide (MoS₂) and the polymer base B includes either ultrahigh molecular weight polyethylene (hereinafter “UHWPE”) or polyetherimide (hereinafter “PEI”). In high temperature applications, the polymer base B preferably includes polyetherimide/PEI such that the cage 10 is configured to operate at a temperature, i.e., the “working temperature”, of up to two hundred degrees Celsius (200° C.). As such, the cage 10 is configured to function or operate without softening of the composite material M, such that the cage 10 remains dimensionally stable and does not bind with the rolling elements 4 or with the inner and outer rings 2, 3.

Alternatively, the reinforcing fibers F may include glass strands, glass spheres, Kevlar or any other appropriate reinforcing materials. The lubricant L within the composite material M may alternatively include graphite, polytetrafluorethylene (“PTFE”) or another appropriate lubricant material capable of mixing with a polymer base material.

Referring to FIGS. 5 and 6, the annular body 12 preferably includes at least one cavity 18 and/or groove 20 formed in each enclosed surface 16 defining a pocket 14. Each cavity 18 and each groove 20 is configured to contain a quantity of lubricant so as to reduce friction between the rolling element 4 and the pocket 14, a portion of which may be transferred by the rolling elements 14 to the raceways (not indicated) of the inner and/or outer rings 2, 3. Preferably, the lubricant disposed within the cavities 18 or grooves 20 is a lubricant adapted for use in a vacuum environment, such as for example, a multiply alkylated cyclopentane (“MAC”) based grease thickened with PTFE (e.g., NyeTorr® 6200) or a PTFE thickened perfluoropolyether grease (e.g., NyeTorr® 6300). However, the lubricant contained within the cavities 18 and/or grooves 20 may be any other appropriate lubricant suitable for the particular application of the bearing 1.

Furthermore, with the composite material M having a polymer base B of UHMWPE, the present bearing cage 10 has a stiffness of about five hundred megapascals (500 MPA), a glass transition temperature about negative eighty degrees Celsius (−80° C.), a maximum working temperature of about one hundred degrees (100° C.), a percent total mass loss due to outgassing in a vacuum of about 0.06 and a coefficient of friction (μ) against the rolling elements 4 of about 0.2. Alternatively, when the composite material M has a polymer base B of PEI, the present bearing cage 10 has a stiffness of about six thousand, seven hundred megapascals (6700 MPA), a glass transition temperature about two hundred twenty degrees Celsius (220° C.), a maximum working temperature of about two hundred degrees (200° C.), a percent total mass loss due to outgassing in a vacuum of about 0.58 and a coefficient of friction (μ) against the rolling elements 4 of between about 0.35 and 0.4.

In comparison, a bearing cage formed of PEEK has a stiffness of about seven thousand, five hundred megapascals (7500 MPA), a glass transition temperature about one hundred thirty-five degrees Celsius (135° C.), a maximum working temperature of about one hundred twenty degrees (120° C.), a percent total mass loss due to outgassing in a vacuum of about 0.2 and a coefficient of friction (μ) against the rolling elements 4 of about 0.3. Thus, the present cage 10 has lower friction and greater dimensional stability than a PEEK cage when the base polymer B is UHMWPE, although the stiffness and maximum working temperature are lower. Further, the cage 10 with a base polymer B of PEI has a much higher working temperature and similar stiffness compared to a PEEK cage, but greater friction and less dimensional stability. However, with either base polymers B, the present cage 10 has a significantly lower manufacturing cost in comparison with a PEEK cage, as discussed in detail below.

Referring now to FIGS. 7-9, the present bearing cage 10 is preferably formed in accordance with the following fabrication method. First, a tube 30 formed of the desired composite material M. i.e., having a specific polymer base B, desired percentage and type of the reinforcing fibers F and a desired percentage and type of the lubricant L is provided. Next, an outer surface 32 of the tube 30 is machined to a desired outside diameter OD_{C} of the cage 10 and an inner surface 34 of the tube 30 is machined to a desired inside diameter ID_{C} of the cage 10 as indicated in FIG. 7. Then, as shown in FIG. 8, the tube 30 is cut to provide at least one annular portion having a desired axial length AL, the portion forming the annular body 12 of the cage 10. Further, as depicted in FIG. 9, a plurality of pockets 14 are machined in the annular body 12 so as to be spaced circumferentially about a centerline L_{C} of the body 12, such that each pocket 14 extends radially between the inner surface 13A of the body 12 and the outer surface 13B of the body 12. Finally, if cavities 18 or grooves 20 are desired for retaining lubricant, these cavities 18 and/or grooves 20 are machined in at least one and preferably all of the enclosed inner surface of the pockets 14. However, the present cage 10 may be formed in any other desired manner or method, such as by injection molding, machining entirely from a circular disc, etc.

Due to both the preferred manufacturing method and material composition as described above, with either polymer base B, the present bearing cage 10 has a substantially reduced manufacturing cost in comparison with a cage formed of PEEK. Specifically, the cost to manufacture a cage 10 from the composite material M including UHMWPE as the polymer base B is about five percent (5%) of the cost to manufacture a similar cage from PEEK, in other words, a ninety-five percent (95%) reduction in cost. Also, the cost to manufacture a cage 10 from the composite material M including PEI as the polymer base B is about thirty percent (30%) of the cost to manufacture a similar cage from PEEK or a seventy percent (70%) cost reduction.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A cage for a bearing, the bearing including inner and outer rings and a plurality of rolling elements disposed between the inner and outer rings, the cage comprising:
an annular body formed of a composite material and having a centerline, the body being sized to be disposed between the inner and outer rings and having a first axial end, a second axial end, an inner circumferential surface, an outer circumferential surface and a plurality of pockets spaced circumferentially about the centerline, disposed between the first and second axial ends and extending radially between the inner and outer circumferential surfaces, each pocket being sized to receive a separate one of the rolling elements, the composite material including a mixture of a polymer base, reinforcing fibers and a lubricant.

2. The bearing cage as recited in claim 1, wherein:
an amount of the reinforcing fibers in the composite material is between ten percent by weight and thirty percent by weight; and
an amount of the lubricant in the composite material is between one-half percent by weight and ten percent by weight.

3. The bearing cage as recited in claim 1, wherein an amount of the reinforcing fibers in the composite material is about thirty percent by weight and an amount of the lubricant in the composite material is about five percent by weight.

4. The bearing cage as recited in claim 3, wherein the reinforcing fibers includes short strand carbon fibers and the lubricant includes molybdenum disulfide.

5. The bearing cage as recited in claim 4, wherein the polymer base includes ultrahigh molecular weight polyethylene or polyetherimide.

6. The bearing cage as recited in claim 1, wherein at least one of:
the reinforcing fibers includes short strand carbon fibers; and
the lubricant includes molybdenum disulfide.

7. The bearing cage as recited in claim 1, wherein the polymer base includes one of ultrahigh molecular weight polyethylene and polyetherimide.

8. The bearing cage as recited in claim 1, wherein the polymer base includes polyetherimide and the cage is configured to operate at a temperature of up to two hundred degrees Celsius.

9. The bearing cage as recited in claim 1, wherein each one of the plurality of pockets is defined by a separate one of plurality of enclosed surfaces formed in the annular body and the annular body further includes at least one cavity and/or at least one groove formed in each enclosed surface, each cavity and/or groove being configured to contain a lubricant.

10. The bearing cage as recited in claim 1 wherein the annular body is formed from a tube formed of the composite material which has an outer surface machined to a desired outside diameter and an inner surface machined to a desired inside diameter, and then a portion of the tube is cut to a desired axial length and the plurality of pockets are machined in the portion of the tube.

11. The bearing cage as recited in claim 1, wherein a coefficient of friction between the annular body and each one of the rolling elements has a value of less than 0.25.

12. A method of forming a cage for a bearing having an inner ring, an outer ring and a plurality of rolling elements disposed between the inner and outer rings, the method comprising the steps of:
providing a tube of a composite material, the composite material including a mix of a base polymer, reinforcing fibers and lubricant;
machining the outer surface of the tube to a desired outside diameter of the cage and the inner surface of the tube to a desired inside diameter of the cage;
cutting the tube to provide at least one annular body having a desired axial length of the cage; and
machining a plurality of pockets in the annular body spaced circumferentially about a centerline of the body, each pocket extending radially between the inner surface of the body and the outer surface of the body.

13. The method as recited in claim 12, further comprising the step of machining at least one cavity and/or at least one groove in an inner surface of at least one of the pockets, the cavity and/or the groove being configured to contain lubricant.

14. The method as recited in claim 12, wherein:
an amount of the reinforcing fibers in the composite material is between ten percent by weight and thirty percent by weight; and
an amount of the lubricant in the composite material is between one-half percent by weight and ten percent by weight.

15. The bearing cage as recited in claim 12, wherein an amount of the reinforcing fibers in the composite material is about thirty percent by weight and an amount of the lubricant in the composite material is about five percent by weight.

16. The bearing cage as recited in claim 12, wherein the reinforcing fibers includes short strand carbon fibers and the lubricant includes molybdenum disulfide.

17. The bearing cage as recited in claim 12, wherein the polymer base includes ultrahigh molecular weight polyethylene or polyetherimide.

18. A cage for a bearing, the bearing including inner and outer rings and a plurality of rolling elements disposed between the inner and outer rings, the bearing cage comprising:
an annular body formed of a composite material and having a centerline, the body being sized to be disposed between the inner and outer rings and having a first axial end, a second axial end, an inner circumferential surface, an outer circumferential surface and a plurality of pockets disposed between the first and second axial ends and extending radially between the inner and outer circumferential surfaces, each pocket being sized to receive a separate one of the rolling elements and the plurality of pockets being spaced circumferentially about the centerline, the composite material including a mixture of a polymer base, reinforcing fibers in an amount of between ten percent by weight and thirty percent by weight, and a lubricant in an amount of between one-half percent by weight and ten percent by weight.

19. The bearing cage as recited in claim 18, wherein an amount of the reinforcing fibers in the composite material is about thirty percent by weight and an amount of the lubricant in the composite material is about five percent by weight.

20. The bearing cage as recited in claim 19, wherein the base polymer includes ultrahigh molecular weight polyethylene or polyetherimide, the reinforcing fibers includes short strand carbon fibers and the lubricant includes molybdenum disulfide.
